(19) United States
(12) Patent Application Publication
(10) Pub. No.: US 2017/0217041 A1
(43) Pub. Date: Aug. 3, 2017

(54) LOG SAW PUSHER ASSEMBLY

(71) Applicant: Kimberly-Clark Worldwide, Inc., Neenah, WI (US)

(72) Inventors: Logan P. Janka, Rochester Hills, MI (US); Barry W. Clocker, Broken Arrow, OK (US)

(21) Appl. No.: 15/501,327

(22) PCT Filed: Aug. 5, 2015
(86) PCT No.: PCT/US15/43807

§ 371 Date: Feb. 2, 2017

Related U.S. Application Data
(60) Provisional application No. 62/043,520, filed on Aug. 29, 2014.

(51) Int. Cl. B26D 7/06; B65G 47/84; B65G 25/08

(52) U.S. Cl. CPC B26D 7/0608; B65G 25/08; B65G 47/844

(57) ABSTRACT

The unitary pusher arms of the present invention may be easily and quickly changed out of a receptive base to accommodate different log saw configurations. The increased modularity is an improvement over prior art pusher arms, which are difficult to change and generally require the loosening and fastening of several different fasteners. Not only are the present arms easy to change out, they may also be color coordinated with different product types so that an operator may quickly and easily identify the appropriate size and shaped pusher to be used with a given product. These advantages improve operational efficiency, reduce the likelihood of mismatched pusher and log size, and increase operator safety.

### BACKGROUND

Conventionally, the manufacture of rolled tissue products such as toilet tissue, kitchen towels or like products requires a number of processing steps, including unwinding the tissue web from a large diameter log, rewinding the web on a smaller diameter log, sealing a tail of the log, cutting the log into roll products of a smaller length suitable for consumer's use, and packaging the roll products.

The cutting operation to form rolls of a smaller length is usually conducted within a sawing apparatus that receives logs wound from an upstream rewinding machine. The construction of a sawing apparatus conventionally includes a saw blade rotated in orbit relative to an axis within a cutting plane transvers to a direction of feeding of an elongated log. A pushing paddle is used to convey by pushing a tail of one log, which thereby travels through the saw blade. Conventionally, the pushing paddle advances the log continuously as a cutting blade is moved into position to cut the log into individual rolls of tissue. In certain log saws a clamping system is used to hold the log in place while the saw blade cuts a roll out of the log. The sawing apparatus known in the prior art has some disadvantages which need improvement. For example, pushing paddles generally consist of several metallic parts that may interfere with the rotating saw blade causing the blade to fail. Blade failure results in wasteful machine downtime and creates a safety hazard for operators having to clean up and replace the blade. Additionally, prior art pushing paddles often consist of several different interconnected parts that are ultimately connected to, and advanced by, a timing belt. Because of the number of different parts it is often difficult and time consuming to replace pusher paddles.

Therefore, there is presently a need for improved pushing paddles that will improve log saw operational efficiency and safety.

### SUMMARY

To improve both log saw operational efficiency and safety, the present invention provides improved log saw pusher assemblies. The assemblies are adjustable and readily changeable, and may be mounted and removed by an operator using a single hand. The assemblies generally comprise a unitary, non-metallic, pusher arm, a base and a paddle. The improved assemblies provided herein lessen the likelihood of blade failure as a result of interference between the blade and the pusher assembly.

Accordingly, in one embodiment the present invention provides a log saw pusher assembly comprising a unitary pusher arm having a substantially vertical arm, a paddle and a base portion, wherein the paddle, the base and the arm are integrally formed with one another, a pusher arm holder adapted to receive the base portion and a means for fastening the base portion to the pusher arm holder.

In other embodiments the present invention provides a log saw pusher assembly comprising a substantially vertical arm having a first end and a second end, a paddle disposed at the first end and a base portion disposed at the second end, the paddle and base integrally formed with the arm to form a unitary pusher arm; a pusher arm holder adapted to receive the base portion and a fastener for releasably joining the holder and the unitary pusher arm.

In another embodiment the present invention provides a log saw pusher assembly comprising a unitary polyurethane pusher arm having a substantially vertical arm with a first and a second end, a paddle disposed at the first end and a base portion disposed at the second end, the base portion having a recess for receiving a threaded fastener; a pusher arm holder adapted to receive the base portion, the holder having a threaded bore adapted to receive a threaded fastener; and a threaded fastener for releasably joining the holder and the unitary pusher arm.

In still other embodiments the present disclosure provides a log saw pusher assembly comprising a molded thermoplastic pusher arm having an arm, a paddle and a base, the base having a substantially rectangular portion orientated perpendicular to the axis of the arm and having a front edge with a mounting flange depending downward therefrom, and a holder having a front face with a recessed portion disposed thereon, the recessed portion adapted to receive the mounting flange.

In yet another embodiment the present invention provides an apparatus for conveying a tissue log comprising a continuous endless belt driven between a pair of wheels; a pusher assembly disposed on the continuous endless belt, the pusher assembly comprising a unitary pusher arm comprising a substantially vertical arm, a paddle and base, and a pusher arm holder adapted to receive the base; and a pair of spaced apart links shaped to support a tissue log, the links sufficiently spaced to facilitate the passage of the pusher assembly there between.

Other features and aspects of the present invention are discussed in greater detail below.

### DESCRIPTION OF THE DRAWINGS

Various non-limiting embodiments are further described with reference to the accompanying drawings in which:

FIG. 1 illustrates a perspective view of a log saw pusher assembly according to one embodiment of the present invention;

FIG. 2 illustrates a perspective view of a log saw pusher assembly according to one embodiment of the present invention;

FIG. 3 illustrates a perspective view of a log saw pusher assembly according to one embodiment of the present invention;

FIG. 4 illustrates a perspective view of a log saw pusher assembly according to one embodiment of the present invention; and

FIG. 5 illustrates a perspective view of a plurality of log saw pusher assemblies in-use in a log conveyance apparatus.

### DETAILED DESCRIPTION

The converting industry is in need of an assembly that is not only rigid, but provides sufficient contact with, or guiding for, the product throughout the full diameter range of the product. Moreover, the apparatus should be compatible with a wide range of log saws and should be easily serviced by an operator. Further, it is desirable that the apparatus be constructed of a material and of a form that it does not cause damage to a saw blade in the case of interference. Moreover, when there is an interference event, the apparatus should be easily replaceable. To solve this problem, a novel type of pusher assembly is provided. The invention provides an apparatus that is rigid and easily installed without the changing of any components or secondary fine tuning.

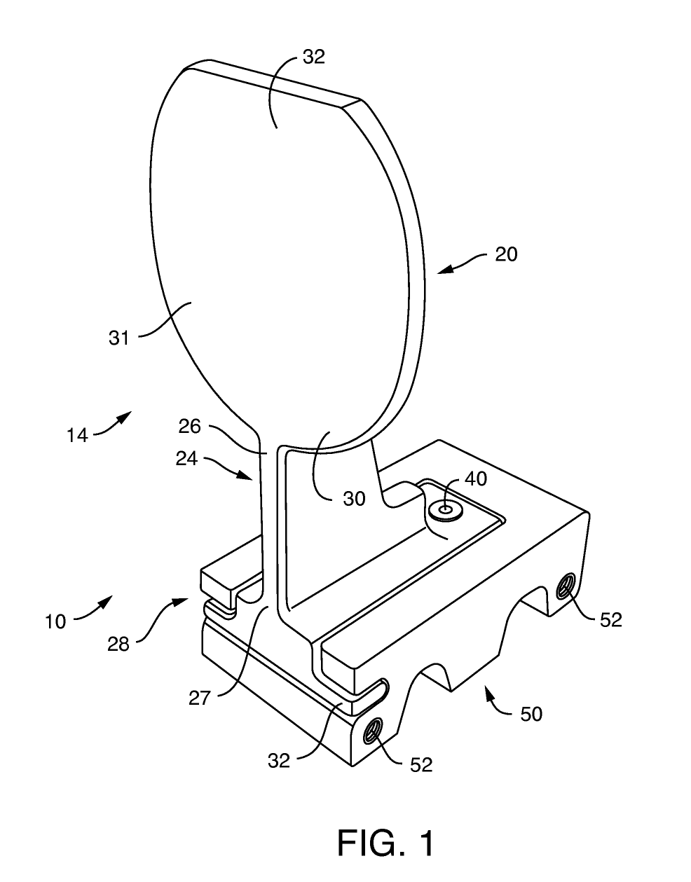

With reference now to the figures, illustrated in FIG. 1 is a pusher assembly 10 according to one embodiment of the present invention. The pusher assembly 10 comprises a unitary pusher arm 14 and a holder 50. The unitary pusher arm 14 generally comprises a substantially vertical arm 24 disposed between a paddle 20 and a mounting base 28. All three components 20, 24, 28 are formed from a single piece of material to yield a unitary pusher arm 14. The arm 24, which is substantially vertical in orientation, extends between and joins the paddle 20 and the mounting base 28 (also referred to herein simply as the base). Generally the paddle 20 is disposed at the arm's first end 26 and the base is disposed at the arm's second end 27. The height of the arm 24, and in-turn the distance between the paddle 20 and the base 28, may be varied to accommodate use of the pusher arm in different log saws as needed.

As discussed further below, the pusher assembly is a unitary, non-metallic piece; that is, the arm, paddle and base are formed of a single piece of non-metallic material. The single piece construction allows for the arm to be rigid and durable, yet allows for rapid and easy removal and installation. For example, by forming the pusher assembly as a single piece that is disenagable from the holder an operator may simply remove the pusher arm rather than disconnect the entire pusher apparatus from the log conveying apparatus.

With further reference to FIG. 1 the paddle 20 is generally disposed at the arm's first end 26 and integrally formed therewith. The paddle 20 has a front face 31 which generally is the log contacting surface. As such the front face is generally shaped to aid in the advance of a tissue log, typically tissue spirally wound around a core, in the log saw. While the paddle's front face is generally illustrated herein as semi-circular, the shape of the paddle is not so limited. The paddle may be any suitable shape to advance a material into a saw. The illustrated paddle 20 is circular along its bottom portion 30 to facilitate the advancement of a round tissue log along a semi-circular support frame. The top portion 32 is generally planar to reduce the likelihood of interference between the paddle 20 and log clamp.

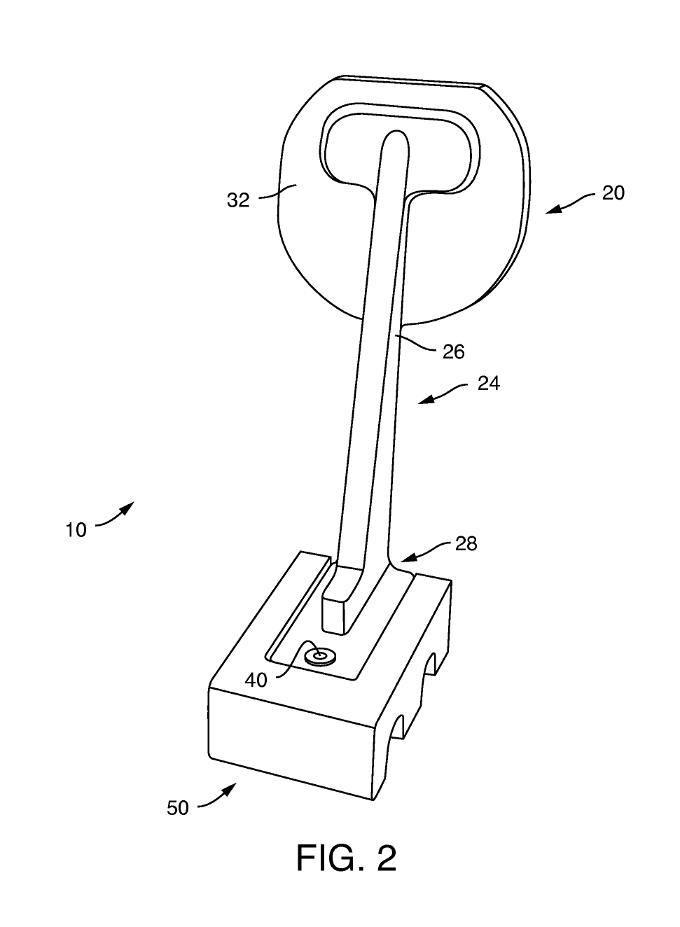

Now with reference to FIG. 2, the pusher assembly 10 is illustrated from the rear. Again, the unitary pusher arm 14 comprises an integrally formed paddle 20, arm 24 and base 28. The paddle 20 generally extends from and is integrally formed with the arm's first end 26. As illustrated, in certain embodiments, the arm 14 may extend along the paddle's rear surface 32 to further reinforce and stabilize the paddle 20. One skilled in art will appreciate that a variety of mold shapes and material may be employed to achieve the desired paddle stiffness, stability and durability and that the illustrated embodiment is only one possibility.

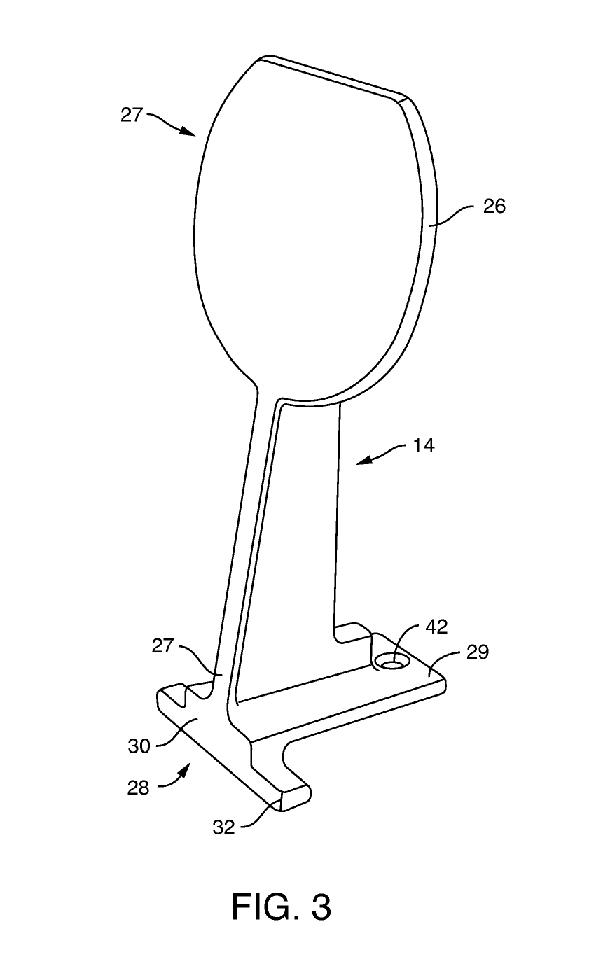

With reference to FIG. 3, the unitary pusher arm 14 is illustrated in further detail. The base 28 is disposed at the second end of the arm 27 and integrally formed therewith. In the illustrated embodiment the base 28 comprises a substantially planar plate 29 that is generally perpendicular to the arm 24. The shape of the base and its orientation relative to the arm however, are not so limited. Generally the base may be any shape to accommodate mounting the unitary pusher arm 14 to a holder 50. Preferably the base is shaped so as to provide stability and rigidity when the unitary pusher arm 14 is mounted to the holder 50. The base 28 may include one or more holes or recesses 42 for receiving a fastener to facilitate fastening of the pusher arm 14 to the holder 50.

In one preferred embodiment the base 28 comprises a planar plate 29 having a front edge 30 and a mounting flange 32 extending therefrom. The mounting flange 32 is generally shaped to be received by a recess 54 disposed along the holder's front face 55. In the illustrated embodiment the mounting flange 32 is substantially T-shaped with protrusions extending away from and substantially perpendicular to the planar plate 29. The mounting flange 32 provides additional stability and rigidity to the pusher arm 14 when it is mounted to the holder 50, such as in the embodiment illustrated in FIG. 1. Additionally, the mounting flange provides the benefit that the unitary pusher arm may be coupled with the holder and held in place without the aid of fasteners and without additional assistance from an operator. This arrangement allows an operator to mount and fasten the pusher arm to the holder with a single hand, simplifying and expediting the process of replacing pusher arms.

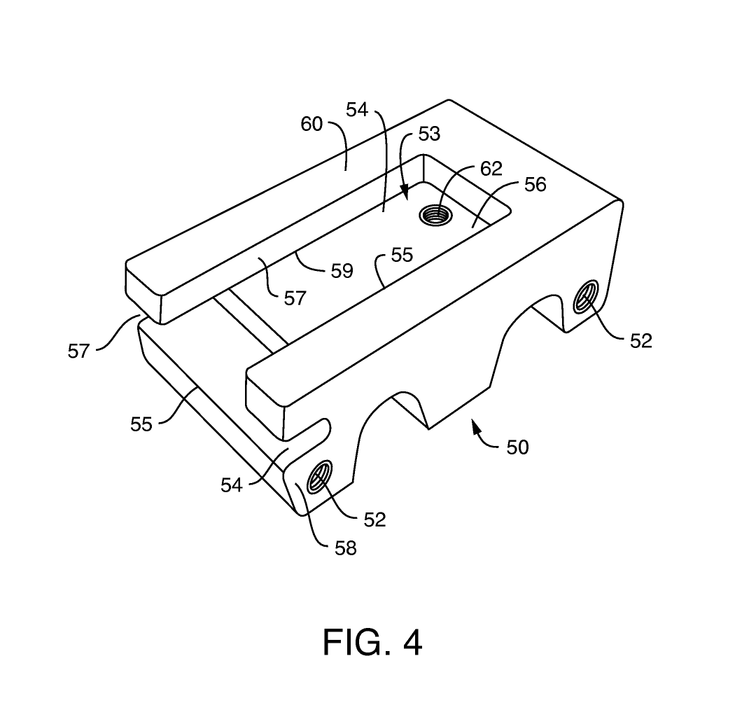

Once the pusher arm 14 is mounted on the holder 50 it is preferably retained in place by a fastening means. As illustrated in FIGS. 1 and 2, one preferred fastening means is a conventional threaded mechanical fastener 40 such as a screw, bolt or the like. For example, the base 28 may be removably fastened to the holder 50 via a threaded bolt 40 that is disposed in a recess 42 on the base plate 29 and received by a counter-threaded bore in the holder (illustrated as 62 in FIG. 4).

Now with reference to FIG. 4, a detailed view of the holder 50 is provided. In the illustrated embodiment, the holder 50 is shaped to receive the pusher arm base in a slidable, disenagable fashion. To accommodate and retain the base in this manner the holder 50 comprises a depressed central portion 53 bounded along its two sides 54, 55 and rear 56 by an elevated sidewall 57 with an overhanging shoulder 59. The overhanging shoulder 59 and depressed central portion 53 define a base receiving zone for receiving and engaging the base of a unitary pusher arm in a slidable manner. Generally the overhanging shoulder defines a void having a profile that matches the outer edge profile of the base plate. Once the base is slid into place it may be affixed to the holder using a conventional fastener such as a screw, bolt or the like.

In other embodiments the holder and base may be engaged by mechanical means other than mechanical fasteners, such as by clips or deformable lock members. For example, in one embodiment the holder comprises a deformable lock member that is adapted to be depressed downwardly into the face of the depressed central portion, but biased to return to an undepressed position when the base is slid into the depressed central portion of the holder. In other embodiments the base or holder may be provided with flexible leaves or springs that are deformed when the base is slid into the depressed central portion of the holder.

In other embodiments, such as that illustrated in FIG. 4, the holder 50 may comprise a recessed portion 54 disposed along its front face 55. The recessed portion 54 is generally shaped to receive one or more flanges 32 extending from the base 28. In the illustrated embodiment the recess 54 extends across the length of the front face 55 between the lateral base side edges 57, 58. However, the illustrated shape of the recess is non-limiting and other widths, depths and shapes are contemplated. By receiving and engaging the base flanges with the holder recess, the overall stability and rigidity of the pusher assembly may be increased. Furthermore, by disposing the recess along the front face of the holder the pusher arm flanges may be readily engaged and received when the arm is slid into engagement with the holder.

To install the unitary pusher arm into the holder the base plate is aligned with the overhanging shoulders and slid toward the holder's depressed central portion to mate the base with the upper face of the holder. The base is slid into the holder until the mounting flange engages the recess, at which point the pusher arm is mounted in a sufficient stable fashion for the operator to release the assembly and allow it to stand freely. If a mechanical fastening means is being used to affix the pusher arm to the holder, the operator may then select an appropriate fastener and use it to join the two pieces.

The unitary pusher arms of the present invention may be easily and quickly changed out to accommodate different log saw types. The increased modularity is an improvement over prior art pusher arms, which are difficult to change and generally require the loosening and fastening of several different fasteners. Not only are the present arms easy to change out, they may also be color coordinated to correspond to different product saw types and saws having varying lane configurations for conveying logs. Color coding allows an operator to quickly and easily identify the appropriate size and shaped pusher to be used with a given log saw. These advantages improve operational efficiency, reduce the likelihood of mismatched pusher and log size, and increase operator safety.

Further, the holder may be easily removable from the log conveying apparatus by providing the holder with a removable fastening means. For example, in one embodiment such as that illustrated in FIG. 4, the holder may be provided with one or more threaded recesses 52 which are adapted to receive a threaded fastener such as a screw or a bolt. The threaded fastener may in-turn attach the holder to an endless belt or the like in a removable fashion.

The unitary pusher arm 14 is generally formed from a single material and may be formed by injection molding, blow molding, vacuum forming, machining, casting or the like. Preferably the unitary pusher arm 14, including the pusher arm 24, paddle 20 and base 28, is formed form a non-metallic material that yields a unitary piece that is rigid and without bonds between discrete portions of the arm. The use of a non-metallic material is particularly preferred as it reduces the likelihood of saw blade failure in the event that the saw blade interferes with the pusher arm. Prior art pushers are generally formed from metal and cause catastrophic blade failure when there is interference. The use of non-metallic materials thus is a vast improvement which increases operational efficiency and operator safety.

Non-metallic materials useful in the present invention may include, for example, one or more plastics, polymers, thermoplastics, thermosets, combinations thereof, or the like. Suitable resins of the foregoing non-metallic materials can be or include resins containing nitrogen, oxygen, halogen, sulfur or other groups capable of interacting with one or more aromatic functional groups such as a halogen or acidic groups. In one or more embodiments, the unitary pusher arm 14 is made from resins including, but not limited to, polyamides, polyimides, polycarbonates, polyesters, polysulfones, polylactones, polyacetals, acrylonitrile-butadiene-styrene resins (ABS), polyphenyleneoxide (PPO), polyphenylene sulfide (PPS), polystyrene, styrene-acrylonitrile resins (SAN), styrene maleic anhydride resins (SMA), aromatic polyketones (PED and PEKK), polyetheretherketones (PEEK), epoxy, phenolic silicone, cyanoacrylates, anaerobics and acrylics, and mixtures thereof. Suitable thermoplastics and thermosets may include, but are not limited to, polythene, polyethersulphone, and polyvinylchloride (PVC). The non-metallic material may also include nylon, polytetraflouroethelene (PTFE), and epoxy resins cured by amines.

Particularly preferred are thermoplastic resins. The thermoplastic resin for use in the present invention is not particularly restricted and various types of thermoplastic resin may be employed. Useful thermoplastic resins include, for example, polyolefin-based resins (e.g., polypropylene, propylene/ethylene copolymer, propylene/butene copolymer, polyethylene, ethylene/vinyl acetate copolymer, ethylene/acrylate copolymer, ethylene/acrylic acid copolymer, and ionomer), cyclic hydrocarbon-based resins (e.g., cyclic olefin copolymer), polystyrene-based resins (e.g., polystyrene resin, acrylonitrile/styrene copolymer (AS resin), acrylonitrile/butadiene/styrene copolymer (ABS resin), methacrylate/styrene copolymer (MS resin), methacrylate/butadiene/styrene copolymer (MBS resin), styrene/maleic anhydride copolymer (SMA resin), styrene/conjugated diene copolymer, and hydrogenated compounds of these copolymers (SBS, SIS, SEBS, SEPS and SBBS)), styrene-based elastomer compositions (e.g., compositions composed of at least one type selected from the group consisting of styrene/conjugated diene copolymer and hydrogenated compound thereof, non-aromatic-based softening agent for rubber, and polyolefin-based resin), polyamide-based resins (e.g., polyamide and polyamide-based elastomer), polyester-based resins (e.g., polyester and polyester-based elastomer), polyurethane-based resins (e.g., polyurethane and polyurethane-based elastomer), polyvinyl-based resins, and polycarbonate-based resins. Of these, olefin- and polyurethane-based resins are particularly preferable.

In certain embodiments the olefin-base resin includes resins having olefin-derived repeating units in an amount of 50 percent by weight or more. It includes homopolymers of α-olefins having 20 or less carbon atoms, e.g. ethylene, propylene, butene-1, pentene-1, hexene-1,3-methylbutene-1 and 4-methylpentene-1; copolymers obtained by copolymerization of at least two kinds of monomers selected from the aforementioned α-olefins; and copolymers of those α-olefins and other unsaturated monomers copolymerizable with those α-olefins.

In a particularly preferred embodiment the unitary pusher arm is formed by injection molding using an olefin-based resin and more preferably a polypropylene resin. In other embodiments the olefin-based resin may be mixed with an additive to improve the wear characteristics of the pusher arm. For example, the wear resistance of the composite may be improved by melt mixing at least one crystalline polymer with a polyamide and polypropylene resin, the crystalline polymer being functionalized to graft with at least one of the polyamide and polypropylene resins to form the composite. Examples of the polypropylene resin include homopolymers of propylene and copolymers of propylene with at least one kind of monomer selected from the group consisting of ethylene and α-olefins having 4 to 12 carbon atoms. These homopolymers and copolymers may be used alone or in combination. Examples of the α-olefins having 4 to 12 carbon atoms include 1-butene, 4-methyl-1-pentene, 1-hexene, and 1-octene. The copolymers of propylene with at least one kind of monomer selected from ethylene and α-olefins having 4 to 12 carbon atoms desirably are copolymers containing at least 50 percent by weight of repeating units derived from propylene, which may henceforth be referred to as “propylene units,” based on 100 percent by weight of the copolymers.

Generally the pusher assemblies of the present invention are useful for the advancement of product during cutting, and more particularly, to advance product for cutting by a saw which transversely severs logs of wound sheet material such as logs of bathroom tissue or kitchen toweling. For example, in the production of rolls of bathroom tissue or kitchen towels, a jumbo sized parent roll of web material is unwound, transversely perforated, and rewound into a log which has the diameter of the final product. The log is cut into individual rolls of bathroom tissue or kitchen towels by a log saw. The pusher assemblies of the present invention are useful for advancing the log in the log saw.

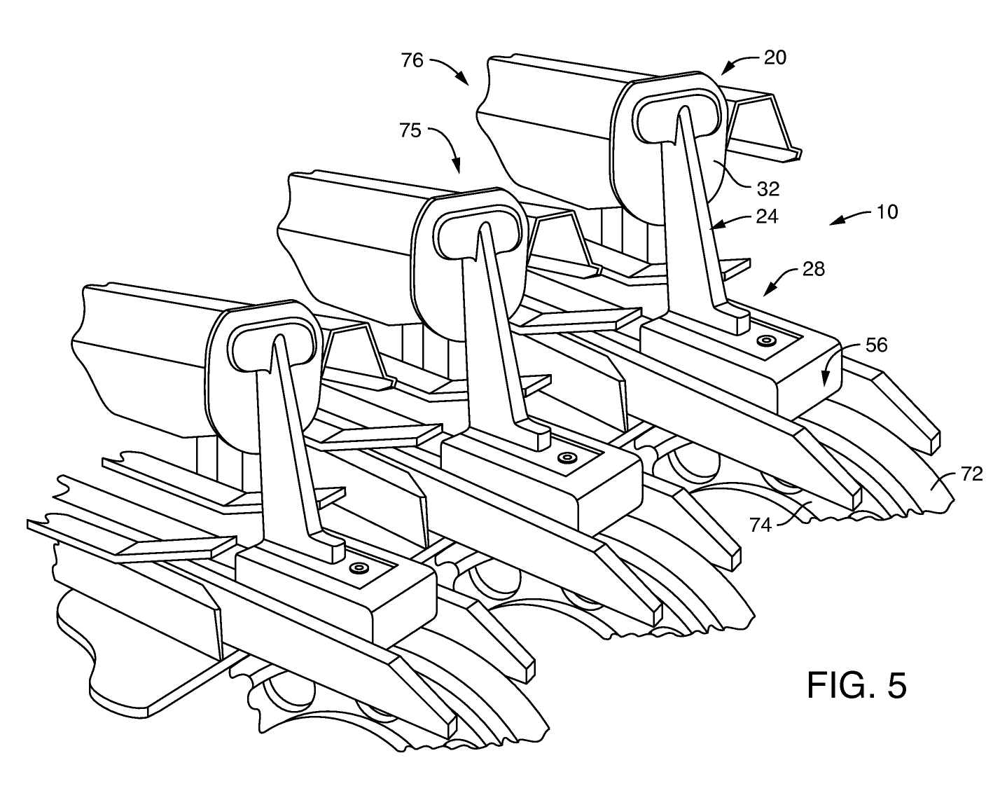

With reference to FIG. 5, a representative log saw apparatus for use with the inventive pusher assemblies is illustrated. The log saw apparatus generally comprises support assemblies, one upstream and one downstream of the blade path. The support assemblies can be set up for single or multiple lanes of product. Each support assembly includes non-adjustable stationary guides above the product. The guides are formed so as to support product through a portion of the diameter range.

Logs are moved axially toward a blade path of a log saw by the pusher assemblies 10. The particular log saw illustrated is a three lane saw, wherein three separate tissue logs are cut during each pass of the blade. However, the invention can be used with greater or fewer lanes. Each log includes a hollow core and convolutely wound web material.

Each log is made to advance by means of a series of pusher assemblies 10, three of which are illustrated in FIG. 5. The pusher assemblies 10 are borne by an endless chain or belt 72 driven between wheels 74. The pusher assemblies 10 push the logs (not illustrated) with a continuous motion at a non-constant speed towards a cutting group (not illustrated), wherein each log is cut to form a plurality of small rolls of wound tissue product. In practice, the machine is capable of simultaneously cutting several logs, for example two or three logs, located parallel to each other.

The log is supported by a support assembly which comprises a pair of spaced apart bottom links 75, 76 which circumscribe a semi-circular path. The circular outer surface of a round log is thereby supported partially along its bottom periphery. The links are rigid and form rigid supporting surfaces for the log. The right and left bottom links 75, 76 are spaced on opposite sides of a vertical plane which extends through the axial centerline of the log. The vertical arms 24 of the pusher assembly 10 can therefore pass between the links to push the log through the support assemblies.

While the pusher assembly is compatible with prior art log saws, the assembly is distinct from prior art pushers in that it comprises a single unitary piece and is releasably attached to a holder. For example, with reference to FIG. 1, the pusher arm 24, paddle 20 and base 28 are formed form a single piece of material are joined to one another without the aid of fasteners or the like. Generally the single unitary piece, which comprises the pusher arm 24, paddle 20 and base 28 is referred to herein as the unitary pusher arm 14. The unitary pusher arm 14 comprises a base portion 28 disposed at its second end 27 which may be fastened to a holder 50 to form the log saw pusher assembly 10.

While in the foregoing specification a detailed description of a specific embodiment was set forth for the purpose of illustration, it will be understood that many of the details herein given may be varied considerably by those skilled in the art without departing from the spirit and scope of the invention.

Accordingly, in a first embodiment the present invention provides a log saw pusher assembly comprising a unitary pusher arm having a substantially vertical arm, a paddle and a base portion, the paddle and base integrally formed with the arm; a pusher arm holder adapted to receive the base portion and a means for fastening the base to the holder.

In a second embodiment the present invention provides the log saw pusher assembly of the first embodiment wherein the means for fastening the base to the holder is selected from a threaded fastener, a mechanical fastener, and deformable locking member.

In a third embodiment the present invention provides the log saw pusher assembly of the first or the second embodiment wherein the means for fastening the base to the holder is a mechanical fastener comprising a spring biased fastener.

In a fourth embodiment the present invention provides the log saw pusher assembly of any one of the first through the third embodiments wherein the means for fastening the base to the holder consists of a threaded screw or threaded bolt and the holder comprises a threaded recess adapted to receive the screw or bolt.

In a fifth embodiment the present invention provides the log saw pusher assembly of any one of the first through the fourth embodiments wherein the holder comprises a substantially rectangular central depressed section bonded on at least two of its sides by an overhanging shoulder, the holder adapted to receive the base in a slidable arrangement.

In a sixth embodiment the present invention provides the log saw pusher assembly of any one of the first through the fifth embodiments wherein the base comprises a substantially rectangular planar plate having a front edge and a mounting flange extending from the front edge and the holder has a recessed portion disposed along its front face, the recessed portion adapted to receive the mounting flange.

In a seventh embodiment the present invention provides the log saw pusher assembly of any one of the first through the sixth embodiments wherein the assembly is formed for a non-metallic material and in a particularly preferred embodiment the non-metallic material is selected from the group consisting of a polyurethane-based resin, an olefin-based resin, a styrene-based resin, an acrylic resin, and an amide resin.

We claim:

1. A log saw pusher assembly comprising a unitary pusher arm having a substantially vertical arm, a paddle and a base portion, the paddle and base integrally formed with the arm; a pusher arm holder adapted to receive the base portion and a means for fastening the base to the holder.

2. The log saw pusher assembly of claim 1 wherein the means for fastening the base to the holder is selected from a threaded fastener, a mechanical fastener, and deformable locking member.

3. The log saw pusher assembly of claim 1 wherein the means for fastening the base to the holder is a mechanical fastener comprising a spring biased fastener.

4. The log saw pusher assembly of claim 1 wherein the means for fastening the base to the holder consists of a threaded screw or threaded bolt and the holder comprises a threaded recess adapted to receive the screw or bolt.

5. The log saw pusher assembly of claim 1 wherein the holder comprises a substantially rectangular central depressed section bonded on at least two of its sides by an overhanging shoulder, the holder adapted to receive the base in a slidable arrangement.

6. The log saw pusher assembly of claim 1 wherein the base comprises a substantially rectangular planar plate having a front edge and a mounting flange extending from the front edge and the holder has a recessed portion disposed along its front face, the recessed portion adapted to receive the mounting flange.

7. The log saw pusher assembly of claim 1 wherein the assembly is formed from a non-metallic material.

8. The log saw pusher assembly of claim 7 wherein the non-metallic material is selected from the group consisting of a polyurethane-based resin, an olefin-based resin, a styrene-based resin, an acrylic resin, and an amide resin.

9. The log saw pusher assembly of claim 8 wherein the pusher assembly is formed by injection molding.

10. A log saw pusher assembly comprising a substantially vertical arm having a first end and a second end, a paddle disposed at the first end and a base portion disposed at the second end, the paddle and base integrally formed with the arm to form a unitary pusher arm; a pusher arm holder adapted to receive the base portion and a fastener for releasable joining of the holder and the unitary pusher arm.

11. The log saw pusher assembly of claim 10 wherein the fastener comprises a threaded screw or threaded bolt and the holder comprises a threaded recess adapted to receive the screw or bolt.

12. The log saw pusher assembly of claim 10 wherein the holder comprises a substantially rectangular central depressed section bonded on at least two of its sides by an overhanging shoulder, the holder adapted to receive the base in a slidable arrangement.

13. The log saw pusher assembly of claim 10 wherein the base comprises a substantially rectangular planar plate having a front edge and a mounting flange extending from the front edge and the holder has a recessed portion disposed along its front face, the recessed portion adapted to receive the mounting flange.

14. An apparatus for conveying a tissue log comprising:
a. a continuous endless belt driven between a pair of wheels;
b. a pusher assembly disposed on the continuous endless belt, the pusher assembly comprising a unitary pusher arm comprising a substantially vertical arm, a paddle and base, and a pusher arm holder adapted to receive the base; and
c. a pair of spaced apart links shaped to support a tissue log, the links sufficiently spaced to facilitate the passage of the pusher assembly there between.

15. The apparatus of claim 14 wherein the pusher assembly further comprises a means for fastening the base to the holder.

16. The apparatus of claim 15 wherein the means for fastening the base to the holder is selected from a threaded fastener, a mechanical fastener, and a deformable locking member.

17. The apparatus of claim 15 wherein the means for fastening the base to the holder is a mechanical fastener comprising a spring biased fastener.

18. The log saw pusher assembly of claim 15 wherein the means for fastening the base to the holder consists of a threaded screw or threaded bolt and the holder comprises a threaded recess adapted to receive the screw or bolt.

19. The log saw pusher assembly of claim 14 wherein the holder comprises a substantially rectangular central depressed section bonded on at least two of its sides by an overhanging shoulder, the holder adapted to receive the base in a slidable arrangement.

20. The log saw pusher assembly of claim 14 wherein the base comprises a substantially rectangular planar plate having a front edge and a mounting flange extending from the front edge and the holder has a recessed portion disposed along its front face, the recessed portion adapted to receive the mounting flange.
